(19) United States
(12) Patent Application Publication
(10) Pub. No.: US 2004/0240623 A1
(43) Pub. Date: Dec. 2, 2004

(54) Device for the examination of samples by means of x-rays

(76) Inventors: Johannes M.H. Van der Veer, Weert (NL); Michel T. Van de Vorst, Eindhoven (NL); Jan Boldewijn, Vriezenveen (NL); Walterus W. Van den Hoogenhof, Almelo (NL)

Correspondence Address: JENSEN + PUNTIGAM, P.S., SUITE 1020, 2033 6TH AVE, SEATTLE, WA, 98121, US

(21) Appl. No.: 10/482,607

(22) PCT Filed: Jun. 20, 2002
(86) PCT No.: PCT/IB02/02397

(30) Foreign Application Priority Data
Jun. 29, 2001 (EP) 01202512.8

(51) Int. Cl. H05G 1/02

(52) U.S. Cl. 378/195

(57) ABSTRACT

A device (1) for the examination of samples by means of X-rays or the like, the device being provided with at least one X-ray source which can be mounted in an exchangeable constructional unit (5) and with an analysis chamber (4) which encloses an exit window (6) of the X-ray source in its operative position and whereto the constructional unit (5) with the X-ray source can be attached. The device is constructed in such a manner that respective, matching parts (9; 10) of a safety system (7) are associated with the analysis chamber (4) and the constructional unit (5) with the X-ray source.

The invention relates to a device as disclosed in the introductory part of claim 1 which includes at least one X-ray source which can be mounted in an exchangeable constructional unit.

The complete X-ray source in devices of this kind can be replaced, for example, in order to enable adaptation to different wavelengths of characteristic radiation by utilizing X-ray sources provided with a different anode material or to enable an exchange of an X-ray source or replacement by a new model.

It is important not to use arbitrary X-ray sources, but only X-ray sources which satisfy the specific requirements of the apparatus. For example, there are contemporary devices of the kind set forth which are completely arranged in a cabinet which can be locked; after the opening of the cabinet, the X-ray source may remain in operation because it is adequately shielded against the escape of radiation. Should the user equip such a device with an X-ray source which is older and not provided with such a shield and hence should be switched off when the cabinet is opened, radiation damage may occur when the device is equipped with such an older X-ray source which leaves the X-ray source switched on also after the opening of the cabinet.

Therefore, it is an object of the invention to restrict the use of X-ray sources in such a manner that only the X-ray sources which are admitted for the relevant device can be built in.

This object is achieved in accordance with the invention by means of a device as disclosed in the characterizing part of claim 1. Reference is made to the claims 2 to 8 for further advantageous embodiments.

When a safety system between the analysis chamber and the constructional unit accommodating the X-ray source is constructed in accordance with the invention, it is ensured that exclusively constructional units with X-ray sources comprising the matching part of the safety system can be utilized.

Since the safety system comprises positive locking parts, it can be very economically manufactured. All electronic recognition circuitry or the like can thus be dispensed with.

The parts of the safety system advantageously have a dual function in that they additionally act as an aid for centering the constructional unit to be attached. Consequently, this unit can be mounted on the analysis chamber in one position only, thus ensuring that the exit window of the X-ray source of the constructional unit automatically occupies the position required for the examination of the samples. Fine adjustment can thus be dispensed with.

When the analysis chamber is provided with a projecting locking pin or similar projecting structural element which can be inserted into a mating pocket hole or similar cavity of the constructional unit, it will be impossible to mount a constructional unit which is not provided with such a recess. This offers simple and reliable protection, for example, against the use of old X-ray sources, or other X-ray sources which are not sufficiently safe, in new devices.

Further advantages and details will become apparent from the embodiment of the invention as shown in the drawing and described in detail hereinafter. In the drawing:

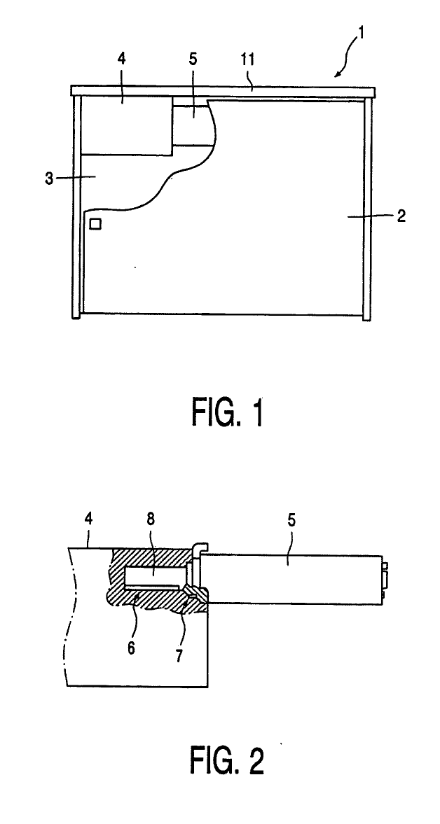

FIG. 1 is a diagrammatic overall view of a device provided with an analysis chamber and a constructional unit to be attached thereto,

FIG. 2 is a partly cut-open detailed view (not to scale) of approximately the part II in FIG. 1,

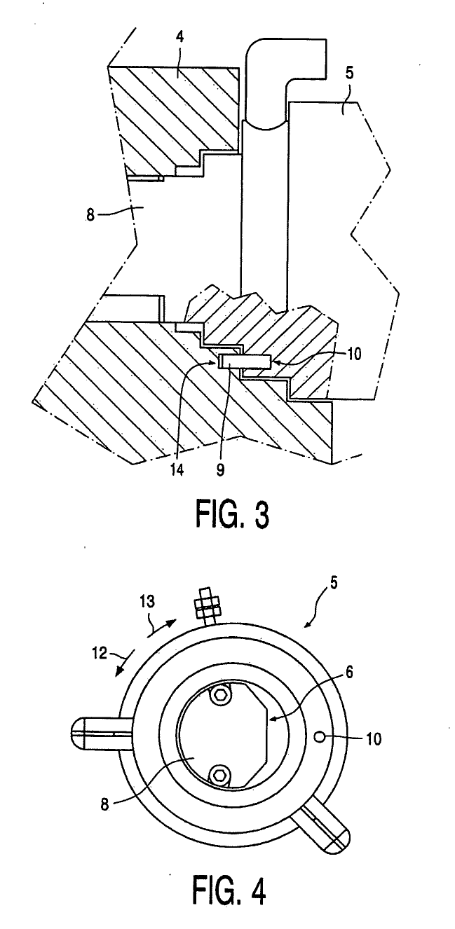

FIG. 3 illustrates the detail III of FIG. 2, and

FIG. 4 is a front view of the constructional unit to be mounted and the X-ray tube accommodated therein.

The device 1 as diagrammatically shown in FIG. 1 includes a cabinet 3 which can be locked by way of one or more doors 2 and in which there are provided an analysis chamber 4 and a constructional unit 5 which includes an X-ray source. It will be evident that the arrangement shown in FIG. 1 is given merely by way of example and that a wide variety of other geometries is also feasible.

The locking door 2 of the cabinet 3 may be constructed as a swing door, as a sheet-like element which can be completely taken off, as a lid which can be opened etc. and hence customarily performs an additional radiation shielding function so that when the cabinet door 2 is closed, the escape of radiation, for example, X-rays, to the environment of the device 1 is minimized.

In contemporary devices 1 the constructional unit 5 with the X-ray source is already provided with such a good radiation shield that maintenance work can be carried out during operation while the cabinet door 2 is open. In the case of older devices, however, the continuing operation of the X-ray source involves the risk of an overdose of radiation to the environment, so that in those cases the opening of the cabinet door 2 often causes actuation of a switch which automatically switches off the X-ray source.

When such switching devices are absent in contemporary devices, it is very important to use an X-ray source provided with such a shielding constructional unit 5 in order to prevent radiation damage to the user.

The complete constructional unit 5 can be exchanged and is constructed in such a manner that a front part 8 which comprises the exit window 6 for X-rays projects into the analysis chamber 4 in the mounted condition, so that the radiation emanating therefrom can be used for the analysis of samples. In accordance with the invention there is provided a safety system (denoted overall by the reference numeral 7) which protects the attachment of the constructional unit 5 with the X-ray source and the analysis chamber 4 to one another.

The protection system 7 (FIG. 3) specifically includes a pin 9 which is associated with the analysis chamber 4 and projects in the direction of the constructional unit 5, said pin entering a pocket hole 10 in the constructional unit 5 in a form-fit fashion. The pocket hole 10 is provided at the front face of the tubular constructional unit 5 (FIG. 4) and hence can be simply formed.

Other safety systems, for example, systems provided with a plurality of projecting elements and a plurality of recesses are also feasible. Moreover, the pin 9 need not be provided directly on the analysis chamber 4 but may also form part, for example, of a cover plate 11 of the device 1; in that case, for example, it would not project into the front wall but in a side wall of the constructional unit 5.

The pin 9 in the embodiment shown at the same time constitutes an aid for centering the constructional unit 5 to be attached, so that it is automatically ensured that this unit can be installed only in such a manner that the exit window 6 for the radiation, notably X-rays, reaches the position in which it is oriented for the examination of samples. Adjustment by rotation of the constructional unit 5 in the direction of the arrows 12, 13 can then be dispensed with.

The safety element associated with the analysis chamber 4 may be constructed, for example, so as to be integral with the wall 14 of the analysis chamber 4 which faces the constructional unit 5. In that case it is ensured that the safety pin 9 cannot be removed. A construction in two parts is also feasible.

The insertion of a constructional unit 5 with an old X-ray source, in which case the constructional unit 5 is not provided with a bore, is then prevented by the projecting pin 9. Consequently, it is only possible to use X-ray sources whose constructional unit 5 is provided with a matching recess and which thus include the matching counterpiece in the safety system 7.

Because of the simplicity and robustness of notably the purely mechanical construction of a safety system 7, manipulations are precluded to a high degree. However, electronic, optical or other safety systems are also feasible so as to achieve the same effect.

1. A device (1) for the examination of samples by means of X-rays or the like, which device includes at least one X-ray source which can be mounted in an exchangeable constructional unit (5) and an analysis chamber (4) which encloses an exit window (6) of the X-ray source in its operative position and whereto the constructional unit (5) with the X-ray source can be attached, characterized in that the constructional unit (5) with the X-ray source and the analysis chamber (4) are provided with respective, matching parts (9; 10) of a safety system (7).

2. A device as claimed in claim 1, characterized in that the safety system (7) comprises parts (9; 10) which engage one another in a form-fit fashion.

3. A device as claimed in one of the claims 1 or 2, characterized in that the safety system (7) forms an aid for centering the constructional unit to be attached.

4. A device as claimed in one of the claims 1 to 3, characterized in that the safety system (7) ensures that only a suitable type of X-ray source can be used.

5. A device as claimed in one of the claims 1 to 4, characterized in that the safety system (7) includes a safety pin (9) which projects from the analysis chamber (4) and enters a recess (10) in the constructional unit (5) to be attached.

6. A device as claimed in claim 5, characterized in that the constructional unit (5) to be attached is provided with a pocket hole (10) which is situated in its zone which faces the analysis chamber.

7. A device as claimed in one of the claims 6 or 7, characterized in that when the safety pin (9) enters the bore (10), the constructional unit (5) to be attached is centered, thus ensuring alignment of the exit window (6) for the X-rays in the analysis chamber (4).

8. A device as claimed in one of the claims 5 to 7, characterized in that the safety pin (9) is constructed so as to be integral with a wall of the analysis chamber (4).
